(19) United States
(12) Patent Application Publication
(10) Pub. No.: US 2012/0081645 A1
(43) Pub. Date: Apr. 5, 2012

(54) REFLECTION TYPE LIQUID CRYSTAL DISPLAY DEVICE FORMED ON SEMICONDUCTOR SUBSTRATE

(75) Inventors: Tetsuo Yoshimura, Yokohama (JP); Michihiro Onoda, Yokohama (JP)

(73) Assignee: FUJITSU SEMICONDUCTOR LIMITED, Yokohama-shi (JP)

(21) Appl. No.: 13/170,804

(22) Filed: Jun. 28, 2011

(30) Foreign Application Priority Data
Sep. 30, 2010 (JP) 2010-221991

(51) Int. Cl. G02F 1/1335; H01J 9/24

(52) U.S. Cl. 349/111; 445/24

(57) ABSTRACT

Above a semiconductor substrate on which switching semiconductor elements are formed respectively corresponding to a plurality of pixels, a first and a second copper wiring layers and thereon an aluminum reflection electrode layer are arranged. Wirings and first and second light shielding layers are formed by patterning the copper wiring layers and pluralities of first and second openings are formed respectively in the first and the second light shielding layers. The first openings and the second openings are shifted in two directions not to overlap each other in a plan view. The wiring layers and the light shielding layers are formed of copper while restraining dishing.

### CROSS REFERENCE TO RELATED APPLICATIONS

This application is based upon and claims the benefit of priority of the prior Japanese Patent Application No. 2010-221991, filed on Sep. 30, 2010, the entire contents of which are incorporated herein by reference.

### FIELD

This invention relates to a reflection type liquid crystal display device and a method for manufacturing a reflection type liquid crystal display device.

### BACKGROUND

Recently a liquid crystal on silicon (LCOS) liquid crystal display device including an active matrix reflection substrate with a switching MOS transistor formed on its silicon layer for each pixel and a reflection electrode formed above the switching MOS transistor for each pixel, a transparent substrate including an opposing transparent electrode, and a liquid crystal layer held in a space between the substrates has attracted attention as a reflective projection type liquid crystal display device. So-called peripheral circuits may be integrated on the silicon layer of the LCOS liquid crystal display device. MOS transistors for high speed operation can be formed on a single crystal silicon substrate.

A liquid crystal display device using an active matrix substrate wherein a display region, a digital/analogue converter, an image signal transfer circuit, a horizontal scanner and a timing controller are formed on a same single crystal silicon semiconductor substrate has been well-known (for example, see JPA2009-134003).

When a liquid crystal display device uses a polarizer and an analyzer, use rate of light may become less than ½. For example, in case of color display by using color filters of R, G and B, use rate of incident light further becomes about ⅓ or less. As a method for increasing use rate of light, there is known a method of color-separating incident light without using color filters, injecting separated color lights to respective liquid crystal display elements, and color-synthesizing the output lights of the liquid crystal display elements. For example, there is known a prism consisting of a combination in which an R-dichroic mirror reflecting red (R) and a B-dichroic mirror reflecting blue (B) are crossed with each other. The prism includes a composition in which the R-dichroic mirrors and the B-dichroic mirrors are formed on surfaces adjacent to right angles of right triangle prisms and are adhered at the right angle parts.

In addition to reflected R-beam and B-beam, a straight forward green (G) beam can be derived by inputting a white beam into the color separating prism. A color-synthesized beam can be derived by inputting R, G and B beams reversely from an output direction to make the same prism function as a color synthesizing prism. When using the color separation and the color synthesis, a liquid crystal display device with three-chips respectively corresponding to R, G and B is used.

A projector projecting output light onto a screen by inputting light emitted from a high-brightness light source such as a high pressure mercury lamp, a halogen lamp, etc. preferably has high use rate of light for obtaining a wide and bright screen area. A projector using the color separating prism, the color synthesizing prism and the LCOS liquid crystal display device for each color is suitable for that usage.

In the LCOS liquid crystal display device, a multiplicity of reflection electrodes corresponding to pixels are arranged. It is necessary to make spaces (gaps) between the reflection electrodes, and there is possibility of allowing light to enter from the spaces between the electrodes. If the incident light reaches the transistor on the semiconductor substrate, an error may occur. Therefore, it is known that a light shielding layer for shielding the light entering from the space between the reflection electrodes is arranged below the reflection electrodes.

There is known a reflection type liquid crystal display device wherein surfaces of a multiplicity of reflection electrodes arranged above a substrate on which pixel switches are formed are polished to be flat, an insulating film such as silicon oxide, etc. is formed to cover the reflection electrodes, the surface of the insulating film is polished to be flat, an orientation structure is formed by oblique angle deposition of insulating material such as silicon oxide, etc. on the surface of the insulating film, and thereafter vertically-aligned liquid crystal is filled between the substrate and an opposing transparent substrate (for example, see JPA 2007-206212). The reflection electrodes are formed of metal having high reflectivity of visible light such as Al, AISi, AICu, etc. The reflecting electrodes are connected to MOS transistors of the pixel switches by using wirings, conductive plugs, etc. A light shielding layer having openings for passing the conductive plugs for connecting the reflection electrodes is arranged below the reflection electrodes.

It is also known that the conductive plugs are formed of W-plugs equipped with barrier metal such as Ti, TiN, etc., and the light shielding layer is formed of Ti, TiN, W, Al or the likes in a similar active matrix substrate (for example, see JPA 2008-9402).

### SUMMARY

According to one embodiment of the invention, a reflection type liquid crystal display device for reflecting incident light and projecting images including a plurality of pixels arranged in two directions includes a semiconductor substrate on which switching semiconductor elements corresponding to respective ones of the pixels are formed, a first insulating layer formed above the semiconductor substrate, a conductive first light shielding layer formed and embedded in the first insulating layer and including a plurality of first openings for each one of the pixels in addition to a gap for insulating a wiring, a second insulating layer formed above the first light shielding layer, a conductive second light shielding layer formed and embedded in the second insulating layer and including a plurality of second openings for each one of the pixels in addition to a gap for insulating a wiring, a third insulating layer formed above the second light shielding layer, reflection electrodes respectively formed on the third insulating layer at positions corresponding to respective ones of the pixels, a liquid crystal layer arranged above the reflection electrodes, and an opposite substrate arranged on the liquid crystal layer, and wherein the first openings and the second openings are arranged not to overlap each other in regards to the two directions in a plan view.

According to another embodiment of the invention, an active matrix reflection substrate adapted for use in a reflection type liquid crystal display device for reflecting incident light and projecting images consisting of a plurality of pixels arranged in two directions, includes: a semiconductor substrate on which switching semiconductor elements corresponding to respective ones of the pixels are formed; a first insulating layer formed above the semiconductor substrate; a conductive first light shielding layer formed and embedded in the first insulating layer and including a plurality of first openings for each one of the pixels in addition to a gap for insulating a wiring; a second insulating layer formed above the first light shielding layer; a conductive second light shielding layer formed and embedded in the second insulating layer and including a plurality of second openings for each one of the pixels in addition to a gap for insulating a wiring; a third insulating layer formed above the second light shielding layer, and reflection electrodes respectively formed on the third insulating layer at positions corresponding to respective ones of the pixels, wherein the first openings and the second openings are arranged not to overlap each other in regards to the two directions in a plan view.

According to still another embodiment of the invention, a method for manufacturing a reflection type liquid crystal display device includes: forming switching semiconductor elements corresponding to respective ones of pixels on a semiconductor substrate; forming a first insulating layer above the semiconductor substrate; forming a conductive first light shielding layer including a plurality of first openings in addition to a gap for insulating a wiring for each one of the pixels, embedded in the first insulating layer by damascene process; forming a second insulating layer above the first light shielding layer; forming a conductive second light shielding layer including a plurality of second openings in addition to a gap for insulating a wiring for each one of the pixels, embedded in the second insulating layer by damascene process; forming a third insulating layer above the second light shielding layer; forming reflection electrodes on the third insulating layer at positions corresponding to respective ones of the pixels, thereby forming an active matrix substrate; and arranging a liquid crystal layer between the active matrix substrate and an opposite substrate, wherein the first openings and the second openings are arranged not to overlap each other in regards to the two directions in a plan view.

According to yet another embodiment of the invention, a method for manufacturing an active matrix reflection substrate, includes: forming switching semiconductor elements corresponding to respective ones of pixels on a semiconductor substrate; forming a first insulating layer above the semiconductor substrate; forming a conductive first light shielding layer including a plurality of first openings in addition to a gap for insulating a wiring for each one of the pixels, embedded in the first insulating layer by damascene process; forming a second insulating layer above the first light shielding layer; forming a conductive second light shielding layer including a plurality of second openings in addition to a gap for insulating a wiring for each one of the pixels, embedded in the second insulating layer by damascene process; forming a third insulating layer above the second light shielding layer; and forming reflection electrodes on the third insulating layer at positions corresponding to respective ones of the pixels, wherein the first openings and the second openings are arranged not to overlap each other in regards to the two directions in a plan view.

The object and advantages of the invention will be realized and attained by means of the elements and combinations particularly pointed out in the claims.

It is to be understood that both the foregoing general description and the following detailed description are exemplary and are not restrictive of the invention, as claimed.

### BRIEF DESCRIPTION OF DRAWINGS

FIGS. 1A, 1B and 1C are plan view and cross sectional views illustrating a structure of an active matrix substrate. FIG. 1A is a plan view schematically illustrating the structure of the active matrix substrate, FIG. 1B is a partial cross sectional view of a peripheral circuit, and FIG. 1C is an enlarged cross sectional view of a structure of a CMOS transistor.

FIGS. 2A and 2B are a cross sectional view and a plan view illustrating a process for manufacturing a display region of the active matrix substrate.

FIGS. 3A and 3B are a cross sectional view and a plan view illustrating a process for manufacturing the display region of the active matrix substrate.

FIGS. 4A and 4B are a cross sectional view and a plan view illustrating a process for manufacturing the display region of the active matrix substrate.

FIGS. 5A and 5B are a cross sectional view and a plan view illustrating a process for manufacturing the display region of the active matrix substrate.

FIG. 6 is a circuit diagram of the display region of the active matrix substrate.

FIGS. 7A and 7B are a cross sectional view and a plan view illustrating a positional relationship between openings of two layers of light shielding layers.

FIGS. 8A and 8B are a cross sectional view of a liquid crystal display device and a diagram illustrating a projector.

### DESCRIPTION OF EMBODIMENTS

An LCOS active matrix substrate using a single crystal silicon (Si) substrate enables formation of a MOS transistor capable of high speed operation and is suitable for integrating a peripheral circuit.

Recently as a semiconductor device getting highly integrated, copper has become widely used for wirings. In the LCOS liquid crystal display device, it is desirable to reduce an occupancy area of the peripheral circuit, and so the usage of the copper wirings is considered. The copper wiring is formed by forming wiring concave part (trench, via-hole, etc.) in an insulating layer, forming a barrier metal layer and a copper seed layer by sputtering or the likes, forming a copper layer on a copper seed layer by electrolytic plating and removing an unnecessary metal layer by chemical mechanical polishing (CMP). For example, it may be considered that two layers of the copper wirings are formed for the peripheral circuit. Moreover, a bonding pad may be formed by using aluminum or aluminum alloy above the copper wirings.

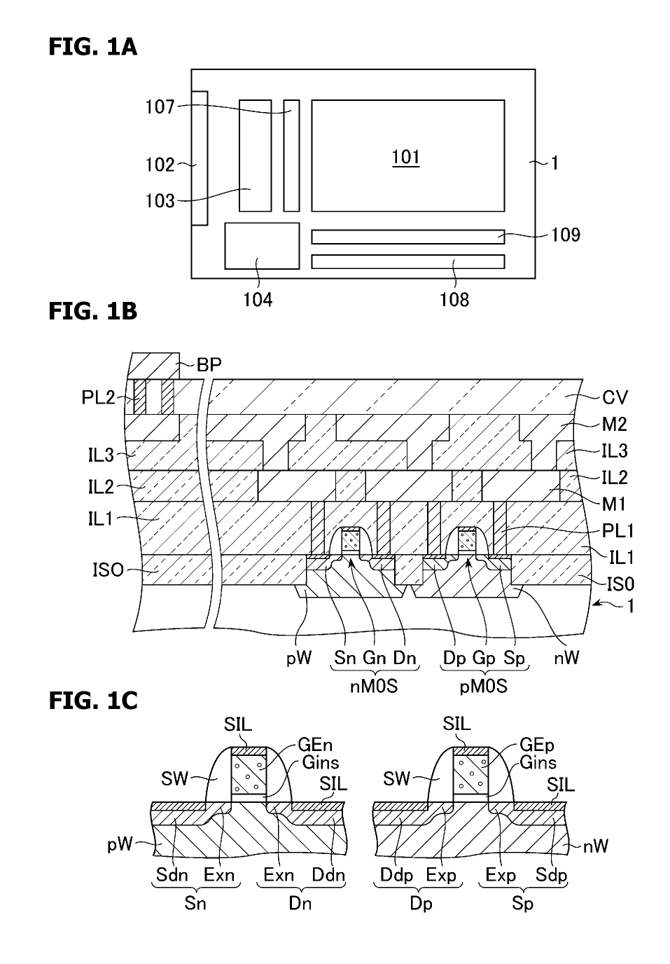

FIG. 1A illustrates an example of a structure of a Si substrate of the LCOS liquid crystal display device. On the Si substrate 1, together with a display region 101 and an input/output pad region 102, peripheral circuits including an input/output circuit 103, a digital-analog converter (DAC) circuit 104, a vertical scanner 107, a decoder 108, an image signal transfer circuit 109, etc. are integrated. The vertical scanner 107, the decoder 108, the transfer circuit 109, etc. may be collectively called a controller circuit. In the display region 101, a switching MOS transistor and a reflection electrode are configured for each pixel, and also a capacitor for maintaining an electrical potential of the reflection electrode is equipped. However, the capacitor may be omitted.

In the LCOS liquid crystal display device, a wiring for connecting one terminal (hereinafter called the source) of the switching MOS transistor with the reflection electrode is necessary, and in addition to that, a data bus line for connecting another terminal (hereinafter called the drain) of the switching MOS transistor with the controller and a gate bus line for connecting a gate electrode of the MOS transistor with the controller are necessary. The gate bus line may be formed by extending a gate electrode made of polysilicon onto an isolation region but it increases resistance. It is preferable to be equipped with a metal gate bus line. The data bus line may be formed of a metal wiring layer. Forming those wiring and light shielding layer with copper wirings similar to the peripheral circuits will be considered.

When the light shielding layer is made of a copper wiring layer, it will become a copper wiring pattern of a large area including openings through which conductive plugs pass. It is known that dishing occurs when a large copper wiring pattern is processed by CMP. Existence of dishing in the light shielding layer may cause light leakage when the light shielding layer becomes too thin and deteriorate planarity of the reflection electrode formed above the dishing. Occurrence of the light leakage deteriorates a function of the light shielding layer. When planarity of the reflection electrode is deteriorated, high contrast vivid image may not be formed and so properties of a projector are deteriorated. An experiment was performed to measure an amount of decrease in film thicknesses of copper wirings by forming a copper wiring pattern by polishing. In the copper wiring pattern of a certain area, copper wiring widths and intervals between the copper wirings are varied, that is, occupancy rates of the copper wirings are differentiated. Providing that a case when a film thickness of the copper wiring is not thicker than a predetermined value is “NG”, almost all the copper wiring widths were NG when the occupancy rates were greater than 90%. When the occupancy rates were greater than 80% (not greater than 90%), the copper wiring widths narrower than a predetermined width were OK but those wider than the predetermined width were NG. When the occupancy rates were not greater than 80%, almost all the copper wiring widths were OK. In accordance with the result of the experiment, in order to restrain the dishing, an occupancy area of the copper wiring layer per unit area is desired to be not greater than 90% depending on a condition, more preferably to be not greater than 80%.

FIG. 1B illustrates an example of a structure of a part of the peripheral circuits. A shallow trench isolation ISO is formed in the Si substrate 1 and demarcates a plurality of active regions. In each active region, a p-type well pW doped with p-type impurities, or an n-type well nW doped with n-type impurities is formed. In the p-type well pW an nMOS transistor including a gate electrode Gn, a source region Sn and a drain region Dn is formed, and in n-type well nW a pMOS transistor including a gate electrode Gp, a source region Sp and a drain region Dp is formed. The suffixes “n” and “p” respectively represents “n-type” and “p-type”.

FIG. 1C illustrates the enlarged nMOS transistor and pMOS transistor. On each surface of the p-type well pW and the n-type well nW, a gate electrode is formed by a lamination of a gate oxide film Gins, a polysilicon gate electrode GE and a silicide layer SIL. The polysilicon gate electrode GE is formed of an n-type polysilicon layer GEn in the nMOS transistor and formed of a p-type polysilicon layer GEp in the pMOS transistor. Side wall spacers SW made of oxide films, nitride films or the likes are formed on side walls of each gate electrode GE. Extensions Exn and Exp are formed to form shallow junctions on both sides of each gate electrode G. On both sides of the side wall spacers SW, source diffusion layers Sd (Sdn, Sdp) and deep drain diffusion layers Dd (Ddn, Ddp) are formed. The source diffusion layers Sd (Sdn, Sdp) and the deep drain diffusion layers Dd (Ddn, Ddp) are deep, and have the same conductivity types as the extensions and high impurity concentrations. On surfaces of the source diffusion layer, the drain diffusion layer and the gate electrode, silicide layers SIL made of cobalt silicide, nickel silicide or the likes are formed.

Returning to FIG. 1B, a first inter-level insulating film IL1 covering the gate electrode structure is formed. Contact holes are formed by etching the first inter-level insulating film IL1, and conductive plugs PL1 made of TiN/W are embedded in the contact holes. A second inter-level insulating film IL2 is formed on the first inter-level insulating film ILL Wiring trenches are formed by etching the second inter-level insulating film IL2, and first copper wirings M1 with a damascene structure are embedded in the trenches. A third inter-level insulating film IL3 is formed on the second inter-level insulating film IL2. Wiring trenches and via holes are formed by etching the third inter-level insulating film IL3, and second copper wirings M2 with a dual-damascene structure are embedded in the trenches and via holes. A cover layer or passivation layer CV is formed to cover the wirings. In a peripheral of a chip, a bonding pad BP is formed on the cover layer CV and connected to the second copper wiring M2 via the conductive plug PL2 piercing through the cover layer CV.

The above described structure is a schematic structure of a CMOS circuit including two layers of copper wirings and is well known. The structure of the CMOS circuit can be selected from various well known structures.

Next mainly a structure of the display region 101 and its manufacturing process will be explained. Two pixels having symmetric structures will be explained as an example.

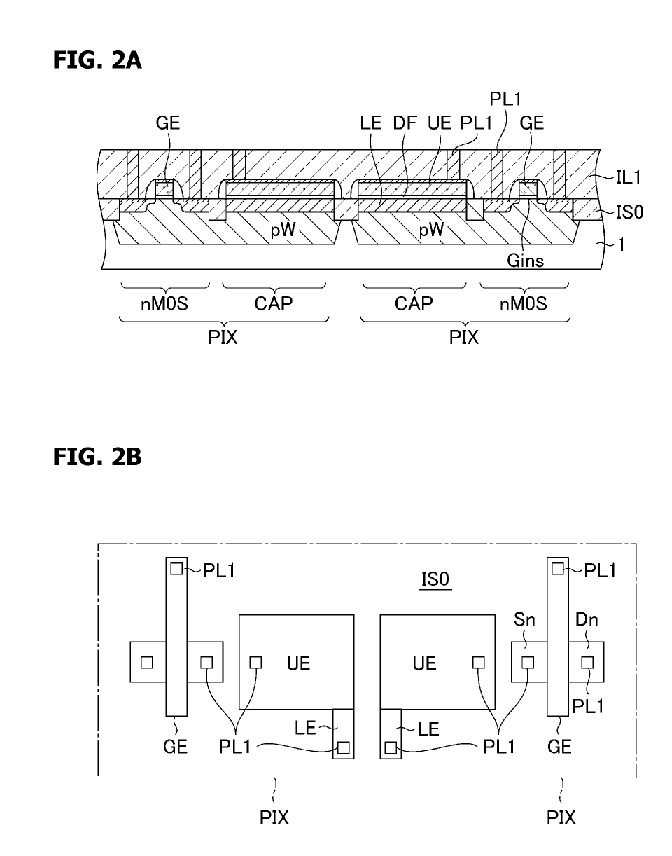

FIG. 2A is a cross sectional view and FIG. 2B is a plan view. As shown in FIG. 2A, an isolation groove demarcating the active regions is formed on the Si substrate 1 by etching. An oxide liner and a nitride liner are formed and thereafter undoped oxide is deposited by high density plasma CVD, and unnecessary parts are removed by CMP to form a shallow trench isolation ISO. In each pixel PIX, a region nMOS where a switching nMOS transistor is formed and a capacitor region CAP where a capacitor is formed are arranged. For each pixel, an n-type well nW and a p-type well pW are formed by ion-implanting n-type impurities and p-type impurities to the active regions by dividing with a photoresist mask. For example, the n-type well nW is formed by ion-implanting n-type impurities such as phosphorus (P), etc. at a dose of 3×10¹³ (hereinafter 3E13) cm⁻², and the p-type well pW is formed by ion-implanting p-type impurities such as boron (B), etc. at a dose of 3E13 cm⁻². The p-type wells pW distributed in a matrix are formed in the display region. A lower electrode LE is formed by ion-implanting high concentration n-type impurities, for example, at a dose of 1E15 cm⁻² to the capacitor region CAP by using a photoresist mask.

An oxide film with a thickness of 2.0 nm is formed by thermally oxidizing a surface of the active region, for example, by partial pressure oxidation at a temperature of 1000 degrees Celsius. The oxide film composes a gate insulating film Gins in the transistor region and a dielectric film DF of the capacitor in the capacitor region. On the oxide film, a polysilicon film, for example, with a thickness of 180 nm is deposited by CVD. After forming a photoresist mask, the polysilicon film is etched by dry-dry etching by using Cl₂, HBr group etchant to patterning a capacitor upper electrode UE and a gate electrode GE.

Covering the n-type active region with a photoresist mask, the extension regions EXn are formed on both sides of the gate electrode by ion-implanting n-type impurities, for example, at a dose of 5E13 cm⁻² to the p-type active region (nMOS region) by using the gate electrode GE as a mask. At the same time, a capacitor upper electrode UE and the gate electrode GE are also ion-implanted. The extension regions EXp are formed by ion-implanting p-type impurities at a dose of 3E12 cm⁻² to the pMOS region in the peripheral circuit region. For example, a TEOS oxide film with a thickness of 95 nm is deposited and anisotropic etching such as reactive ion etching by using CF₄ containing gas, etc. is performed to form the side wall spacers SW on the side walls of the gate electrode GE and the capacitor upper electrode UE.

Covering the n-type active region with a photoresist mask, the source diffusion region Sdn and the drain diffusion region Ddn are formed by ion-implanting n-type impurities at high concentration, for example, at a dose of 4E15 cm⁻² deeply to the p-type active region by using the gate electrode GE and the side wall spacers SW as a mask. At the same time, the capacitor upper electrode UE and the gate electrode GE are also ion-implanted. Source/drain diffusion regions are formed by ion-implanting p-type impurities at a dose of 1E15 cm⁻² to the pMOS region. For example, annealing is performed for three seconds in nitrogen atmosphere at a temperature of 1025 degrees Celsius to activate the ion-implanted impurities.

A metal film made of cobalt or nickel is formed on a whole surface of the substrate, and a thermal process for silicidation is performed. An unreacted film is washed out. The process for manufacturing the switching nMOS transistors also manufactures the nMOS transistors of the CMOS circuit.

An silicon oxide film, for example, made of a TEOS oxide film or the like with a thickness of 900 nm and covering the gate electrode GE and the capacitor upper electrode UE is deposited on the silicon substrate 1 by CVD. The first inter-level insulating film IL1 is formed by polishing the silicon oxide film to have a thickness of 700 nm by CMP. Moreover, a low dielectric insulating film such as porous silica, etc. may be used as an inter-level insulating film. A contact hole with a size of, for example, 0.15 μm×0.15 μm is formed by performing anisotropic etching to the first inter-level insulating film by using CF₄ containing gas as etchant with a photoresist mask having an opening pattern in a contact region. For example, the conductive plug PL1 is formed by depositing a TiN film with a thickness of 20 nm and a W film with a thickness of 200 nm and removing unnecessary part by CMP. The film thickness is a thickness at a flat part.

As shown in FIG. 2B, the nMOS transistor and the capacitor CAP are formed in each pixel PIX with a size of, for example, 6.5 μm×6.5 μm. Each one conductive plug PL1 is connected to each of the lower electrode LE and the upper electrode UE of the capacitor, and to each of the source region Sn, the drain region Dn, and the gate electrode GE of the transistor. For example, when the 1200×800 pixels are arranged, an area of the display region becomes about 8 mm×5 mm.

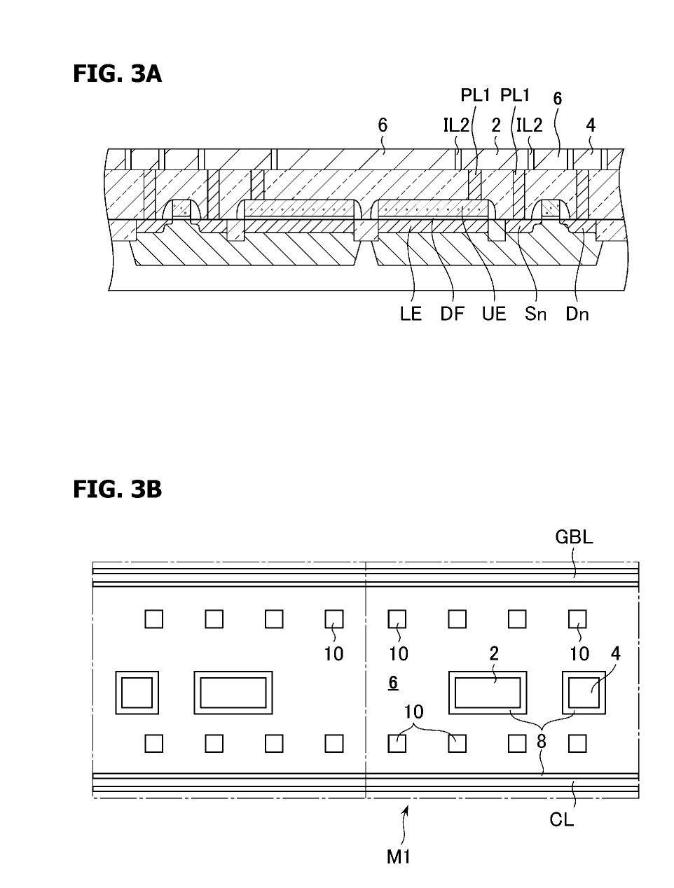

As shown in FIG. 3A, the second inter-level insulating film IL2 is formed on all over the substrate by depositing a silicon nitride film with a thickness of 50 nm by plasma (PE) CVD by using NH₃ and SiH₄ as source gas, and continuously depositing a silicon oxide film with a thickness of 300 nm by PE-CVD by using SiH₄ and O₂ as source gas.

As shown in FIG. 3B, wiring trenches for forming each of a local interconnect 2 for the capacitor upper electrode, a relay interconnect 4 for the data bus line, a gate bus line GBL and a common line CL for a capacitor lower wiring, and a first light shielding pattern 6 with eight openings 10 (four openings 10 by two columns) for each pixel is formed. The first light shielding pattern 6 occupies a region separated from those wirings and interconnects by the insulating spaces. For example, widths of the gate bus line GBL, the common line CL and the spaces 8 on both sides of them may be 0.2 μm, a size of the local interconnect 2 may be 0.55 μm×2 μm, a size of the relay interconnect 4 may be 0.55 μm×1.5 μm, widths of the spaces 8 around the interconnects may be 0.2 μm, and a size of the openings 10 may be 0.55 μm×0.55 μm. For example, a photoresist mask with a wiring pattern is formed, the silicon oxide film is etched by CF₄ containing gas, and the silicon nitride film is etched by CHF₃ containing gas. For example, covering inside the trench, a barrier metal film made of a TaN film with a thickness of 15 nm, and a copper seed layer with a thickness of 130 nm are formed by sputtering, and a copper layer filling up the trench is plated by electrolytic plating. A first metal wiring M1 with a thickness of 270 nm is formed by removing an unnecessary metal layer on the second inter-level insulating film IL2 by CMP with over polish.

As shown in FIG. 3A, the local interconnect 2 connects the source Sn of the transistor with the upper electrode UE of the capacitor via the conductive plugs PL1 and also provides a connecting node for an upper wiring. The relay interconnect 4 pulls out the drain Dn of the transistor upward by cooperating with the conductive plug PL1. The gate bus line GBL shown in FIG. 3B forms a scanning line by connecting the conductive plug PL1 on the gate electrode GE shown in FIG. 2B. The common line CL connects the conductive plug PL1 on the lower electrode LE of the capacitor shown in FIG. 2B and connects the lower electrode of the capacitor to, for example, the ground.

A case of forming the light shielding layer on all over the region where the wirings are not formed with separation from the wirings, for example, by 0.2 μm is examined. In this case, the occupancy area rate of the first metal wiring M1 becomes about 83%, exceeding 80%, and therefore, it becomes not easy to restrain the dishing. By forming the openings 10 in the light shielding layer 6, the occupancy area rate of the first metal wiring M1 decreases to about 77%. Here, however, when the occupancy area rate of a metal wiring is decreased by forming the openings, noisy light input to the substrate via the openings may become a problem. As described in the below, it is preferable to introduce a predetermined rule to an arrangement of the openings to restrain the increase in the input noisy light effectively.

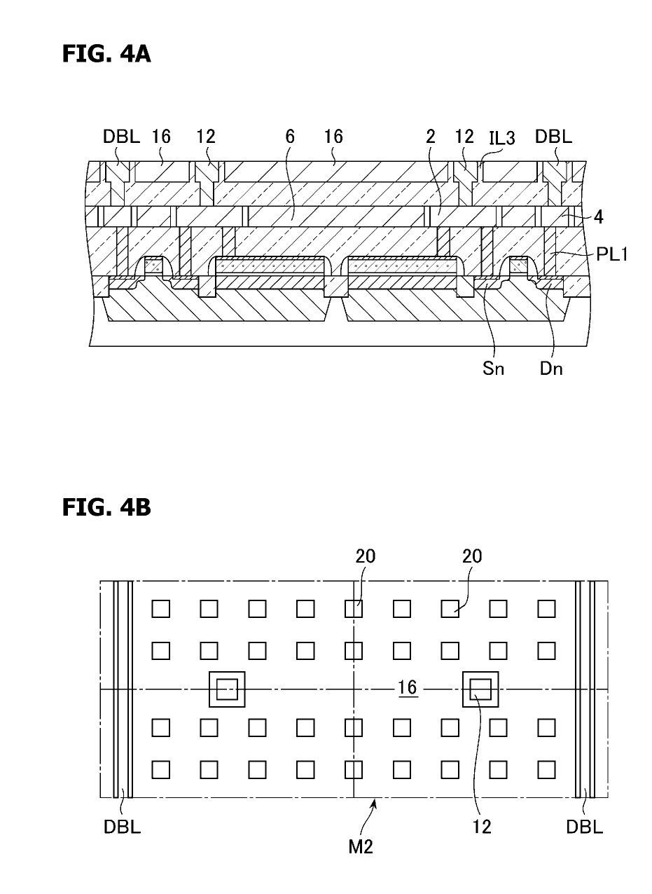

As shown in FIG. 4A, a third inter-level insulating film IL3 is formed, on all over the substrate, by depositing a silicon nitride film with a thickness of 70 nm by plasma (PE) CVD by using NH₃ and SiH₄ as source gas, continuously depositing a silicon oxide film with a thickness of 280 nm by PE-CVD by using SiH₄ and O₂ as source gas, and further depositing a silicon nitride film with a thickness of 40 nm and a silicon oxide film with a thickness of 350 nm respectively by the similar process.

As shown in FIG. 4B, wiring trenches for each of a relay interconnect 12 for reflection electrode, connected to the local interconnect 2 for the capacitor upper electrode, a data bus line DBL, and a second light shielding pattern 16 with eighteen openings 20 (four columns) for each pixel are formed. The second light shielding pattern occupies a region separated from the wirings and interconnects by insulating gaps or spaces. For example, a photoresist mask with wiring pattern is formed, and the trench is formed by etching the silicon oxide film by CF₄ containing gas and the silicon nitride film by CHF₃ containing gas. By the similar process, via holes piercing from the bottom of the wiring trench to the surface of the lower wirings are formed. That is, recesses for dual damascene are formed. The light shielding layer may not be electrically connected and may be in single damascene structure. A TaN film with a thickness of 15 nm and a copper seed layer with a thickness of 130 nm covering inside the recesses are formed by sputtering, and a copper layer filling up the recesses is plated by electrolytic plating. By removing an unnecessary metal layer on the third inter-level insulating film IL3 by CMP with over polish, a second metal wiring M2 made of copper having via holes with a height of 350 nm and wirings in trenches with a thickness of 270 nm is formed.

As shown in FIG. 4A, the relay interconnects 12 are connected to the sources Sn of the transistors and the upper electrodes UE of the capacitors via the local interconnects 2 and the conductive plugs PL1. The data bus lines DBL are connected to the drains Dn of the transistors via the relay interconnects 4 and the conductive plugs PL1. As shown in FIG. 4B, the data bus lines DBL are wirings for supplying image data to the drains Dn of the transistors arranged vertically in the drawing.

A case of forming the light shielding layer in the whole region where the wirings are not formed, with isolating separation from the wirings, for example, by 0.2 μm is examined. In this case, the occupancy area rate of the second metal wiring M2 exceeds 80%, and therefore, it becomes not easy to restrain the dishing. By forming the openings 20 in the light shielding layer 16, the occupancy area rate of the second metal wiring M2 can be set to a desired value not more than 80%, and the dishing may be effectively restrained.

For example, the occupancy area rate of the second metal wiring M2 becomes about 92% by setting widths of the data bus lines DBL and spaces on both sides thereof to 0.2 μm, and setting a size of the relay interconnects 12 to 0.62 μm×0.62 μm and spaces around it to 0.2 μm. When forming eighteen 0.55 μm×0.55 μm openings for each pixel, the occupancy area rate of the second metal wiring M2 becomes about 79%. By forming the openings, the occupancy area rate of the wiring may be 80% or less.

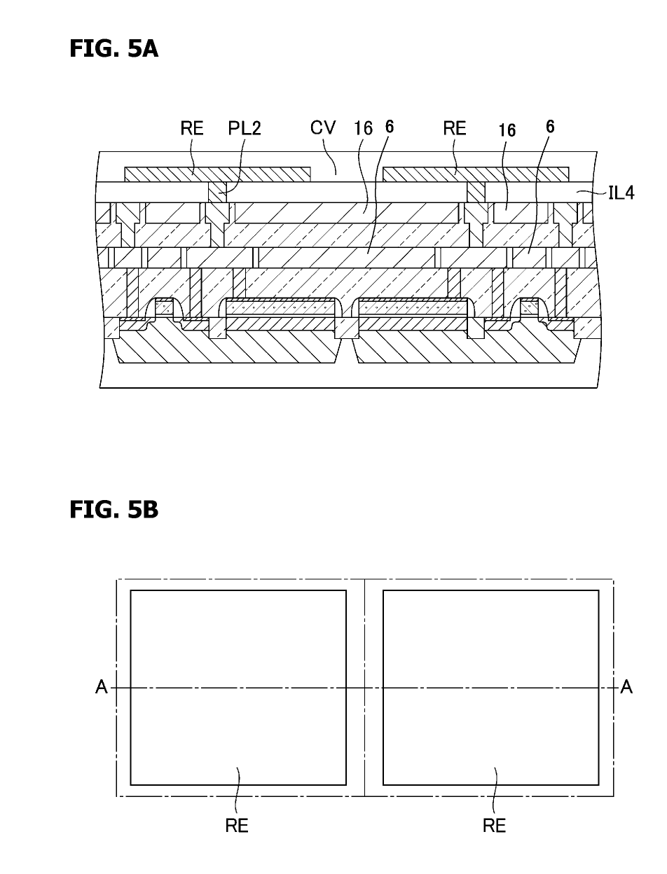

As shown in FIG. 5A, on all over the substrate, a silicon nitride film with a thickness of 70 nm and a silicon oxide film with a thickness of 900 nm are deposited by PE-CVD. The silicon oxide film is polished and planarized to have a thickness of 700 nm to form a fourth inter-level insulating film IL4. By using a photoresist mask, connection holes with a size of 0.42 μm×0.42 μm are etched by etching the silicon oxide film by CF₄ containing gas and the silicon nitride film by CHF₃ containing gas. The connection holes are filled up by depositing a TiN film with a thickness of 50 nm by sputtering and a W film with a thickness of 400 nm by CVD. By removing an unnecessary metal layer on the fourth inter-level insulating film IL4 by CMP, conductive plugs PL2 are formed.

A Ti layer with a thickness of 60 nm, a TiN layer with a thickness of 30 nm and an aluminum-copper alloy layer with a thickness of 250 nm are sputtered on the fourth inter-level insulating film IL4 in which the conductive plugs PL2 are embedded. Reflection electrodes RE are patterned by etching the aluminum alloy layer, the TiN layer and the Ti layer with Cl₂ and BCl₃ containing gas by using a photoresist mask. Thereafter, a cover layer CV made of silicon oxide, etc. is formed. Depending on necessity, an alignment structure is formed by oblique angle deposition of silicon oxide, etc.

FIG. 5B is a plan view illustrating a shape of the reflection electrodes RE. One reflection electrode RE is configured in one pixel. Between the electrodes RE, spaces with, for example, a width of 0.3 μm are formed. Incident light to the spaces from the above can go downward. However, the second light shielding layer 16 exists below the spaces and shields the incident light. The incident light reflected by the second light shielding layer 16 goes further. If the incident light enters from the openings of the second light shielding layer 16, the first light shielding layer 6 shields the light.

In the above explanation, two layers of the copper layers and one aluminum layer are formed on the active matrix reflection substrate. In case of integrating the peripheral circuits in the same substrate as shown in FIG. 1A, two copper wiring layers and one aluminum layer (bonding pad and reflection electrodes) may be formed by the common process by using the common metal layers in the display region and the peripheral circuit region. The formation process of the conductive plugs may also be commonized.

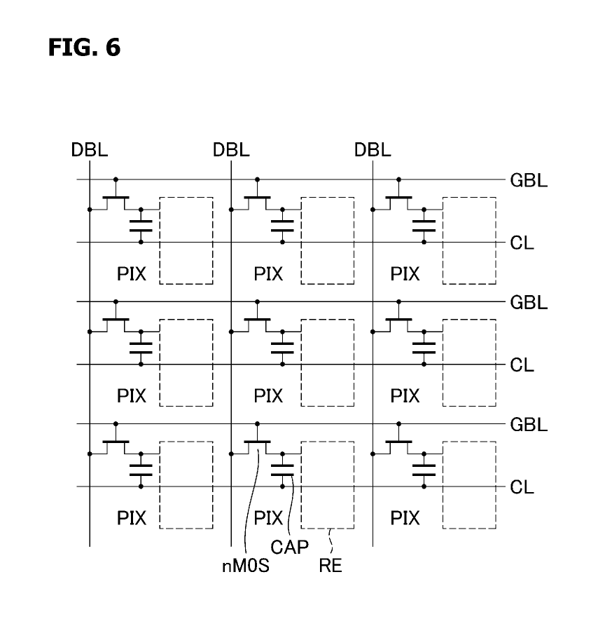

FIG. 6 illustrates a circuit diagram of the active matrix substrate. A plurality of the parallel gate bus lines GBL extend horizontally, a plurality of the parallel data bus lines DBL extend vertically, and the pixel PIX is connected to each crossing point. In each pixel, one current terminal (drain) of the nMOS transistor is connected to the data bus line DBL, the gate electrode is connected to the gate bus line GBL, and another current terminal (source) is connected to the reflection electrode RE. The local interconnect connecting the source and the reflection electrode RE is also connected to one electrode of the capacitor CAP, and another electrode of the capacitor CAP is connected to the common line CL. Although it has been explained that the common line CL is arranged in parallel to the gate bus line GBL, the extending direction of the common line CL may be in parallel to the data bus line DBL or in any direction because it is connected to a fixed electrical potential such as the ground. A plurality of the pixels PIX are aligned in the horizontal (x) direction and the vertical (y) direction, and arranged in a matrix configuration. The directions of the arrangement may be employed as standard directions.

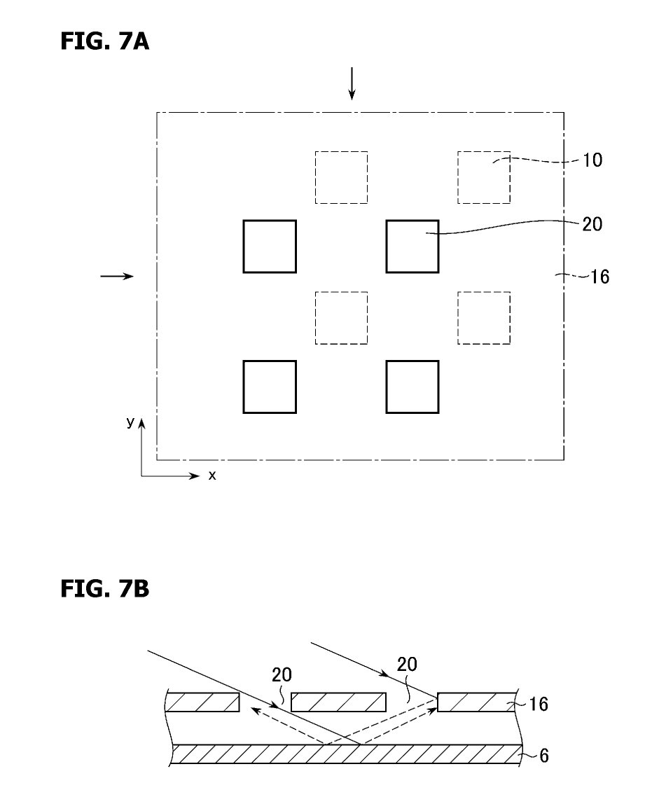

FIG. 7A is a plan view illustrating a region of the second light shielding layer 16 including the openings 20. The openings 10 of the first light shielding layer 6 behind the second light shielding layer 16 is illustrated by broken lines. The display region generally is a rectangle demarcated by sides in x-direction and in y-direction. The standard directions are x-direction and y-direction, and the incident light goes along the x-direction or y-direction, and obliquely in a plane including z-direction. The openings 10 of the first light shielding layer 6 and the openings 20 of the second light shielding layer 16 are shifted in the x-direction and in y-direction not to overlap each other. That is, the openings of the first light shielding layer and the openings of the second light shielding layer are arranged in a houndstooth check, and have no overlaps relating to their x coordinates and y coordinates. Normally a projector has two standard directions, horizontal and vertical directions, and can be used with the longer side at the top or the shorter side at the top. That is, the incident light entering into the openings of the second light shielding layer 16 along the x direction or y direction goes to a region without the openings 10 of the first light shielding layer 6.

FIG. 7B is a cross sectional view illustrating paths of the incident light. The drawing depicts a cross section in the x and z direction including the openings 20 of the second light shielding layer 16. The first light shielding layer 6 does not have the openings 10 in this cross section, and the incident light passing through the openings 20 or reflected by sidewalls of the openings 20 of the second light shielding layer 16 is further reflected by the first light shielding layer 6. The incident light directing to the openings 10 of the first light shielding layer 6 is shielded on its way by the second light shielding layer 16 where the openings 20 do not exist. As in the above, even though the openings are formed, there is basically no light reaching the semiconductor substrate by passing through the openings in the two light shielding layers.

Dishing can be restrained by forming the openings in the light shielding layers. Lightproof can be increased by shifting the positions of the openings of the two light shielding layers in two directions not to overlap each other in a plan view. Number of the manufacturing steps will not increase by forming the light shielding layers and the wirings from the same metal layers.

Moreover, the spaces around the relay interconnects and the spaces on both sides of the bus lines may cause light leakage; however, probability of the light leakage is similar to the prior art, and it may be disregarded because there is almost no light entering into a region covered by the reflection electrodes.

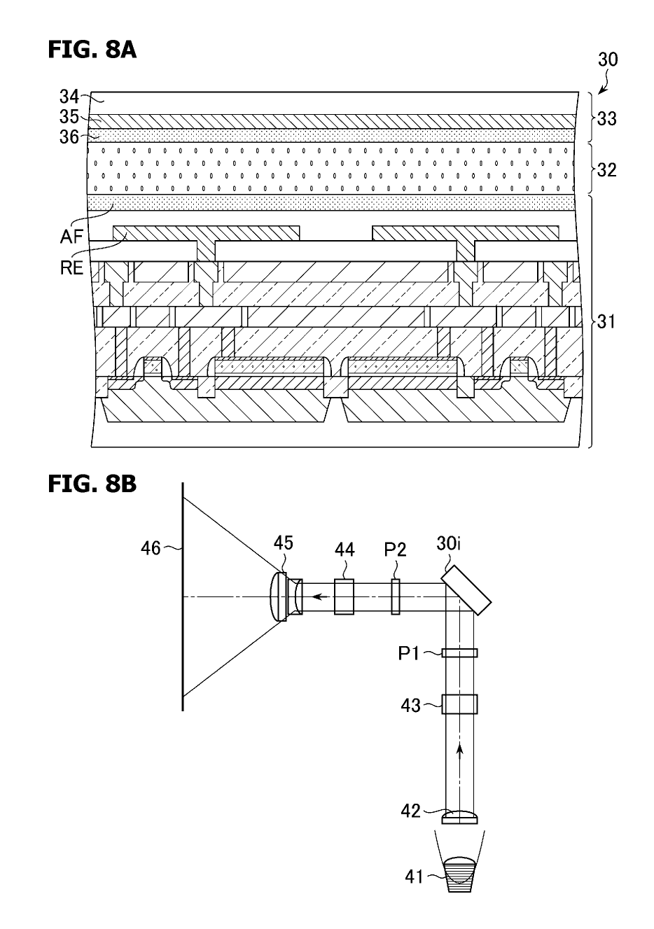

FIG. 8A is a cross sectional view illustrating a liquid crystal display device using the above-described active matrix substrate. The liquid crystal display device 30 includes an active matrix substrate 31, a liquid crystal layer 32 and an opposite substrate 33. The active matrix substrate 31 is a substrate having the above-described structure and includes an orientation film AF on the reflection electrodes RE via the cover layer. For example, the orientation film AF is an oblique-angle-deposition silicon oxide film and gives a pre-tilt angle to vertical alignment liquid crystals. The opposite substrate 33 includes a structure wherein a common electrode 35 made of indium tin oxide (ITO) and an orientation film 36 are formed on a transparent substrate or sheet 34 made of glass or the like. The liquid crystal layer 32 sandwiched between both substrates contains, for example, vertical alignment liquid crystals having negative dielectric anisotropy. Liquid crystal molecules are aligned almost perpendicular to the substrate (vertically) when ON voltage is not applied between the common electrode and the reflection electrodes and are driven to a horizontal position when ON voltage is applied between the common electrode and the reflection electrodes. When combining with a polarizer and an analyzer in a cross Nicole configuration, a black display is created when the ON voltage is not applied, and a white display is created when the ON voltage is applied.

FIG. 8B is a schematic cross sectional view illustrating a structure of a projector. A light flux emitted from a high-brightness white light source 41 such as a high pressure mercury lamp, a halogen lamp, etc. is gathered by a collecting lens 42, irradiated into a color separating prim 43 and separated into three colors (R, G, B) of color light beams. Each color light beam is converted to an image by a polarizer P1, a liquid crystal display device 30i and an analyzer P2 and input into a color synthesizing prism 44. Three optical systems of the same structure are arranged in parallel between the color separating prism 43 and the color synthesizing prism 44. The image light flux color-synthesized by the color synthesizing prism 44 is projected onto a screen 46 by a projector lens 45.

Dishing can be restrained by forming the openings in the light shielding layers. Lightproof can be increased by shifting the positions of the openings of the two light shielding layers in two directions not to overlap each other in a plan view. Number of the manufacturing steps will not increase by forming the light shielding layers and the wirings from the same metal layers.

The present invention has been described in connection with the preferred embodiments. The invention is not limited only to the above embodiments. For example, materials and values in the explanations are just examples and may be altered. A layer described as a copper layer may be formed of a copper alloy layer, and a layer described as an aluminum alloy layer may be formed of an aluminum layer. Moreover, nematic liquid crystals may be used instead of the vertical alignment liquid crystals.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What are claimed are:

1. A reflection type liquid crystal display device for reflecting incident light and projecting images consisting of a plurality of pixels arranged in two directions, comprising:
a semiconductor substrate on which switching semiconductor elements corresponding to respective ones of said pixels are formed;
a first insulating layer formed above said semiconductor substrate;
a conductive first light shielding layer formed and embedded in said first insulating layer and including a plurality of first openings for each one of said pixels in addition to a gap for insulating a wiring;
a second insulating layer formed above said first light shielding layer;
a conductive second light shielding layer formed and embedded in said second insulating layer and including a plurality of second openings for each one of said pixels in addition to a gap for insulating a wiring;
a third insulating layer formed above said second light shielding layer,
reflection electrodes respectively formed on said third insulating layer at positions corresponding to respective ones of said pixels;
a liquid crystal layer arranged above said reflection electrodes; and
an opposite substrate arranged on said liquid crystal layer,
wherein said first openings and said second openings are arranged not to overlap each other in regards to the two directions in a plan view.

2. The reflection type liquid crystal display device according to claim 1, wherein said plurality of the first openings and said plurality of the second openings are arranged in a houndstooth check in a plan view.

3. The reflection type liquid crystal display device according to claim 1, wherein
said first light shielding layer and said second light shielding layer are formed of copper or copper alloy, and
said reflection electrodes are formed of aluminum or aluminum alloy.

4. The reflection type liquid crystal display device according to claim 1, wherein
said first and second light shielding layers comprise a first wiring pattern and a second wiring pattern, which also shield light,
one of said first and second wiring patterns comprises an image signal bus line for supplying image signal to said switching semiconductor elements, and
another one of said first and second wiring patterns comprises a control signal bus line for supplying ON/OFF control signals to said switching semiconductor elements.

5. The reflection type liquid crystal display device according to claim 4, wherein
said first wiring pattern comprises a single damascene structure, and
said second wiring pattern comprises a dual damascene structure.

6. The reflection type liquid crystal display device according to claim 1, wherein
said semiconductor substrate comprises respective capacitors together with said switching semiconductor elements corresponding to said plurality of pixels, and
either one of said first wiring pattern and said second wiring pattern comprises an electrical potential line connected to one electrode of each capacitor.

7. The reflection type liquid crystal display device according to claim 1, wherein
said semiconductor substrate comprises a peripheral circuit,
said peripheral circuit comprises a first wiring layer and a second wiring layer respectively arranged on same levels as said first light shielding layer and said second light shielding layer.

8. An active matrix reflection substrate adapted for use in a reflection type liquid crystal display device for reflecting incident light and projecting images consisting of a plurality of pixels arranged in two directions, comprising:
a semiconductor substrate on which switching semiconductor elements corresponding to respective ones of said pixels are formed;
a first insulating layer formed above said semiconductor substrate;
a conductive first light shielding layer formed and embedded in said first insulating layer and including a plurality of first openings for each one of said pixels in addition to a gap for insulating a wiring;
a second insulating layer formed above said first light shielding layer;
a conductive second light shielding layer formed and embedded in said second insulating layer and including a plurality of second openings for each one of said pixels in addition to a gap for insulating a wiring;
a third insulating layer formed above said second light shielding layer, and
reflection electrodes respectively formed on said third insulating layer at positions corresponding to respective ones of said pixels,
wherein said first openings and said second openings are arranged not to overlap each other in regards to the two directions in a plan view.

9. A method for manufacturing a reflection type liquid crystal display device, comprising:
forming switching semiconductor elements corresponding to respective ones of pixels on a semiconductor substrate;
forming a first insulating layer above said semiconductor substrate;
forming a conductive first light shielding layer including a plurality of first openings in addition to a gap for insulating a wiring for each one of said pixels, embedded in said first insulating layer by damascene process;
forming a second insulating layer above said first light shielding layer;
forming a conductive second light shielding layer including a plurality of second openings in addition to a gap for insulating a wiring for each one of said pixels, embedded in said second insulating layer by damascene process;
forming a third insulating layer above said second light shielding layer;
forming reflection electrodes on said third insulating layer at positions corresponding to respective ones of said pixels, thereby forming an active matrix substrate; and
arranging a liquid crystal layer between said active matrix substrate and an opposite substrate,
wherein said first openings and said second openings are arranged not to overlap each other in regards to said two directions in a plan view.

10. A method for manufacturing an active matrix reflection substrate, comprising:
forming switching semiconductor elements corresponding to respective ones of pixels on a semiconductor substrate;
forming a first insulating layer above said semiconductor substrate;
forming a conductive first light shielding layer including a plurality of first openings in addition to a gap for insulating a wiring for each one of said pixels, embedded in said first insulating layer by damascene process;
forming a second insulating layer above said first light shielding layer;
forming a conductive second light shielding layer including a plurality of second openings in addition to a gap for insulating a wiring for each one of said pixels, embedded in said second insulating layer by damascene process;
forming a third insulating layer above said second light shielding layer; and
forming reflection electrodes on said third insulating layer at positions corresponding to respective ones of said pixels,
wherein said first openings and said second openings are arranged not to overlap each other in regards to said two directions in a plan view.
